(19) United States
(12) Patent Application Publication
(10) Pub. No.: US 2021/0180369 A1
(43) Pub. Date: Jun. 17, 2021

(54) DYNAMIC LOCK MECHANISM

(71) Applicant: GM GLOBAL TECHNOLOGY OPERATIONS LLC, Detroit, MI (US)

(72) Inventors: Ashish Nayak, Bhopal (IN); Vijay Chidamber Deshpande, Bangalore (IN); Santhosh Kumar KB, Bangalore (IN); Jeffrey L. Konchan, Romeo, MI (US)

(73) Assignee: GM GLOBAL TECHNOLOGY OPERATIONS LLC, Detroit, MI (US)

(21) Appl. No.: 16/715,533

(22) Filed: Dec. 16, 2019

(51) Int. Cl. E05B 77/54; E05B 17/20; E05B 83/24

(52) U.S. Cl. CPC E05B 77/54; E05Y 2900/536; E05B 83/24; E05B 17/2057

(57) ABSTRACT

A dynamic lock mechanism includes a lock body defining a longitudinal axis, the lock body including an opening extending from a first end of the lock body to a second end of the lock body, a lock plunger configured to travel within the opening in the lock body such that the lock plunger is enclosed within the opening when the lock plunger is in a first position and at least a portion of the lock plunger extends out of the opening when the lock plunger is in a second position, the lock plunger including a retention channel, a catch member disposed within the lock body and configured to engage with the retention channel of the lock plunger when the lock plunger is in the second position, and a first tensionable member coupled to the lock plunger and a second tensionable member coupled to the catch member.

### INTRODUCTION

The present disclosure relates generally to a dynamic locking mechanism triggered by a change of acceleration, such as a sudden vehicle deceleration.

Upon a sudden deceleration event, vehicle components, such as, for example, a vehicle hood, can contact a vehicle windshield, causing damage and possible impingement of the windshield and/or the hood to the passenger compartment. Therefore, there is a need for a mechanism to prevent undesired motion of vehicle components, such as the vehicle hood, in cases of sudden vehicle deceleration events.

### SUMMARY

Embodiments according to the present disclosure provide a number of advantages. For example, embodiments according to the present disclosure prevent impingement of a vehicle components, such as a vehicle hood, for example, into another vehicle component, such as a vehicle windshield using a dynamic locking mechanism that is triggered by a sudden change in vehicle acceleration.

In one aspect of the present disclosure, a dynamic lock mechanism includes a lock body defining a longitudinal axis, the lock body including a lock body opening extending along the longitudinal axis from a first end of the lock body to a second end of the lock body opposite the first end, the lock body opening open to the environment at the first end, a lock plunger configured to travel within the lock body opening such that the lock plunger is fully enclosed within the lock body opening when the lock plunger is in a first position and at least a portion of the lock plunger extends out of the lock body opening when the lock plunger is in a second position, the lock plunger including a retention edge defining a retention channel, a catch member disposed within the lock body and configured to engage with the retention channel of the lock plunger when the lock plunger is in the second position, and a first tensionable member coupled to the lock plunger and a second tensionable member coupled to the catch member.

In some aspects, the first tensionable member is an extension spring and the second tensionable member is a compression spring.

In some aspects, the lock plunger translates within the lock body opening from the first position to the second position when an inertial force overcomes a spring force of the first tensionable member.

In some aspects, the first position is a disengaged position of the lock plunger and the second position is an engaged position of the lock plunger.

In some aspects, the retention channel is perpendicular to the lock body opening.

In some aspects, the lock body includes an edge defining a receiving opening perpendicular to the lock body opening and the catch member is disposed within the receiving opening.

In some aspects, when the lock plunger is in the second position, the receiving opening of the lock body is aligned with the retention channel of the lock plunger and the second tensionable member translates the catch member into the retention channel such that the catch member engages with the lock plunger.

In another aspect of the present disclosure, an automotive vehicle includes a vehicle body, a vehicle hood coupled to the vehicle body, a bracket coupled to the vehicle hood, the bracket including a bracket opening, and a dynamic lock mechanism coupled to the vehicle body. The dynamic lock mechanism includes a lock body defining a longitudinal axis, the lock body including a lock body opening extending along the longitudinal axis from a first end of the lock body to a second end of the lock body opposite the first end, the lock body opening open to the environment at the first end and a lock plunger configured to travel within the lock body opening such that the lock plunger is fully enclosed within the lock body opening when the lock plunger is in a first position and at least a portion of the lock plunger extends out of the lock body opening and engages with the bracket opening in the bracket when the lock plunger is in a second position.

In some aspects, the lock plunger includes a retention channel and the dynamic lock mechanism further includes a catch member disposed within the lock body, the catch member configured to engage with the retention channel of the lock plunger when the lock plunger is in the second position.

In some aspects, the retention channel is perpendicular to the lock body opening.

In some aspects, the automotive vehicle further includes a first tensionable member coupled to the lock plunger and a second tensionable member coupled to the catch member.

In some aspects, the first tensionable member is a spring.

In some aspects, the lock plunger translates within the lock body opening from the first position to the second position when an inertial force overcomes a spring force of the first tensionable member.

In some aspects, the first position is a disengaged position of the lock plunger with respect to the bracket and the second position is an engaged position of the lock plunger with respect to the bracket.

In some aspects, the lock body includes an edge defining a receiving opening perpendicular to the lock body opening and the catch member is disposed within the receiving opening.

In some aspects, when the lock plunger is in the second position, the receiving opening of the lock body is aligned with the retention channel of the lock plunger and the second tensionable member translates the catch member into the retention channel such that the catch member engages with the lock plunger.

In another aspect of the present disclosure, a dynamic lock mechanism includes a lock body defining a longitudinal axis, the lock body including a lock body opening extending along the longitudinal axis from a first end of the lock body to a second end of the lock body opposite the first end, the lock body opening open to the environment at the first end, a lock plunger configured to travel within the lock body opening such that the lock plunger is fully enclosed within the lock body opening when the lock plunger is in a first position and at least a portion of the lock plunger extends out of the lock body opening when the lock plunger is in a second position, and a tensionable member coupled to the lock plunger. The lock plunger translates within the lock body opening from the first position to the second position when an inertial force overcomes a spring force of the tensionable member.

In some aspects, the lock plunger includes a lock plunger head and a lock plunger engagement member extending from a first side of the lock plunger head and the tensionable member is coupled to the first side of the lock plunger head.

In some aspects, the tensionable member is a spring.

In some aspects, the tensionable member is in an extended position when the lock plunger is in the first position and the tensionable member is in a compressed position when the lock plunger is in the second position and the first position is a disengaged position of the lock plunger and the second position is an engaged position of the lock plunger.

### BRIEF DESCRIPTION OF THE DRAWINGS

The present disclosure will be described in conjunction with the following figures, wherein like numerals denote like elements.

FIG. 1 schematically illustrates a cross-section of a dynamic locking mechanism in a disengaged position, according to an embodiment of the disclosure.

FIG. 2 schematically illustrates a cross-section of the dynamic locking mechanism of FIG. 1 in an engaged position, according to an embodiment of the disclosure.

FIG. 3 schematically illustrates a cross-section of a dynamic locking mechanism in a disengaged position, according to another embodiment of the disclosure.

FIG. 4 schematically illustrates a cross-section of the dynamic locking mechanism of FIG. 3 in an engaged position, according to an embodiment of the disclosure.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import. Throughout the disclosure; like or similar reference numbers refer to like or similar components.

Vehicle events in which sudden deceleration occurs can result in detachment of a vehicle component, resulting in impingement into a vehicle passenger compartment or other undesirable detachment, such as a vehicle hood hitting a vehicle windshield, for example and without limitation. Embodiments discussed herein include a dynamic lock mechanism that triggers during a sudden deceleration event, such as a frontal impact event. Upon the vehicle deceleration event, a lock plunger moves out of a lock body to an engaged position and engages with a bracket coupled to the vehicle component, such as a vehicle hood. In various embodiments, the lock body includes a spring-loaded catch such that once the lock plunger extends from the lock body, the catch engages with the lock plunger to hold the lock plunger in the engaged position. As discussed herein, the dynamic lock mechanism may be used to restrain other vehicle components, such as console or glovebox doors, hatches, etc., for example and without limitation.

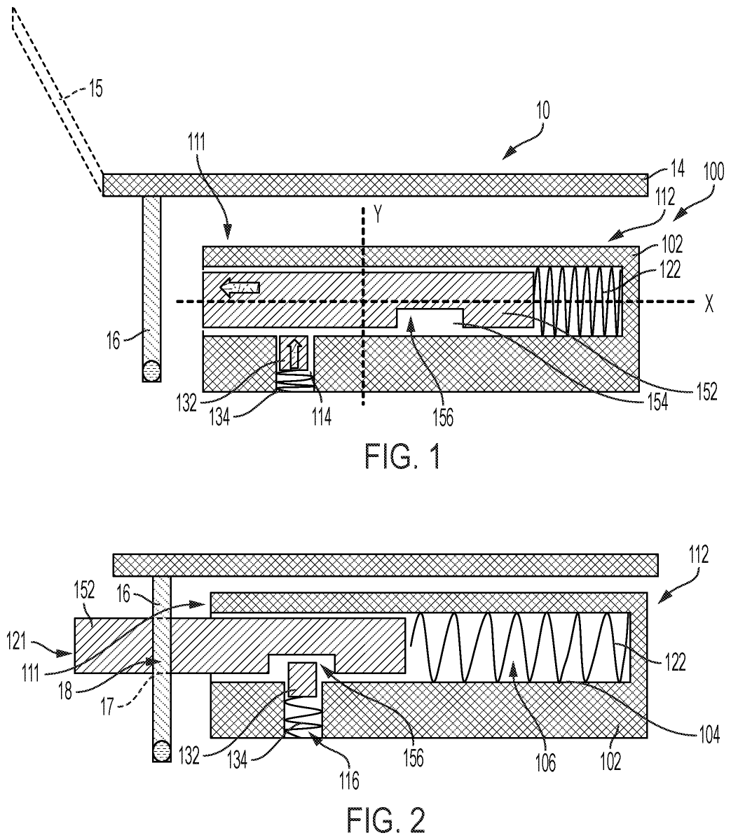

FIGS. 1 and 2 illustrate a dynamic lock mechanism 100, according to an embodiment of the disclosure. A vehicle 10 includes a hood 14 and a windshield 15. The hood 14 is rotatably attached to the vehicle body, and, upon a sudden deceleration event, may become detached and impact the windshield 15. The vehicle 10 further includes a bracket 16 coupled to the hood 14. In various embodiments, as shown in FIG. 2, the bracket 16 includes an edge 17 defining a bracket opening 18 configured to engage with a portion of the dynamic lock mechanism 100.

The dynamic lock mechanism 100 includes a lock body 102 defining a longitudinal axis X. A lateral axis Y extends perpendicular to the longitudinal axis X. An edge 104 forms a lock body opening 106 in the lock body 102. In various embodiments, the lock body opening 106 extends from a first end 111 of the lock body 102 to a second end 112 of the lock body 102 opposite the first end. The lock body opening 106 is open to the environment at the first end 111.

The lock body opening 106 is configured to receive a lock plunger 152. The lock plunger 152 is configured to travel within the lock body opening 106 in the longitudinal direction X such that the lock plunger 152 is fully enclosed within the lock body opening 106 when the lock plunger 152 is in a first or disengaged position (as shown in FIG. 1) and at least a portion of the lock plunger 152 extends out of the lock body opening 106 when the lock plunger 152 is in a second or engaged position (as shown in FIG. 2). The lock plunger 152 includes a retention edge 154 defining a retention channel 156. The retention channel 156 is configured to receive a catch member as discussed in greater detail herein.

The lock plunger 152 is coupled to a tensionable member 122. The tensionable member 122 is received within the lock body opening 106 and is coupled to the second end 112 of the lock plunger 152 and to the closed end of the lock body opening 106. The tensionable member 122 is, in various embodiments, an extension spring or other tensionable member configured to translate the lock plunger 152 within the lock body opening 106. As discussed in greater detail herein, in various embodiments, the tensionable member 122 is an extension spring that is in tension to retain the lock plunger 152 in the disengaged position until inertia forces of the lock plunger 152 due to acceleration caused by a sudden deceleration event of the vehicle 10 stretch out the tensionable member 122, allowing the lock plunger 152 to translate out of the lock body 102 and connect with the bracket 16.

The lock body 102 includes an edge 114 defining a catch member receiving opening 116. The catch member receiving opening 116 is configured to receive a catch member 132 such that the catch member 132 is disposed within the catch member receiving opening 116. The catch member 132 has a first end configured to engage with the retention channel 156 in the lock plunger 152, as shown in FIG. 2. The catch member 132 also includes a second end opposite the first end. The catch member 132 is configured to travel within the opening 116 in the lateral direction Y such that at least a portion of the catch member 132 extends out of the opening 116 when the lock plunger 152 is in an engaged position (as shown in FIG. 2).

The catch member 132 is coupled to a tensionable member 134. The tensionable member 134 is received within the opening 116 and is coupled to the second end of the catch member 132 and to the lock body 102. The tensionable member 134 is, in various embodiments, a spring or other tensionable member configured to translate the catch member 132 within the opening 116. As shown in FIGS. 1 and 2, the tensionable member 134 is in a compressed position when the lock plunger 152 is in the disengaged position and extends to translate the catch member 132 within the opening 116 to engage with the lock plunger 152 in the engaged position.

During normal operation of the vehicle 10, the dynamic lock mechanism 100 is in the disengaged position shown in FIG. 1. Upon a sudden deceleration event, the lock plunger 152 travels longitudinally within the lock body opening 106 in the lock body 102 such that a first end 121 of the lock plunger 152 extends through the opening in the lock body 102 at the first end 111. The first end 121 of the lock plunger 152 extends through the opening 18 to engage with the bracket 16. The catch member 132, which is normally held in the disengaged position shown in FIG. 1 by the lock plunger 152, extends laterally (upward, as shown in FIG. 2), to engage with the retention channel 156 and retain the lock plunger 152 in the engaged position shown in FIG. 2. When the lock plunger 152 is engaged with the bracket 16, the hood 14 is restrained from incursion into the windshield 15.

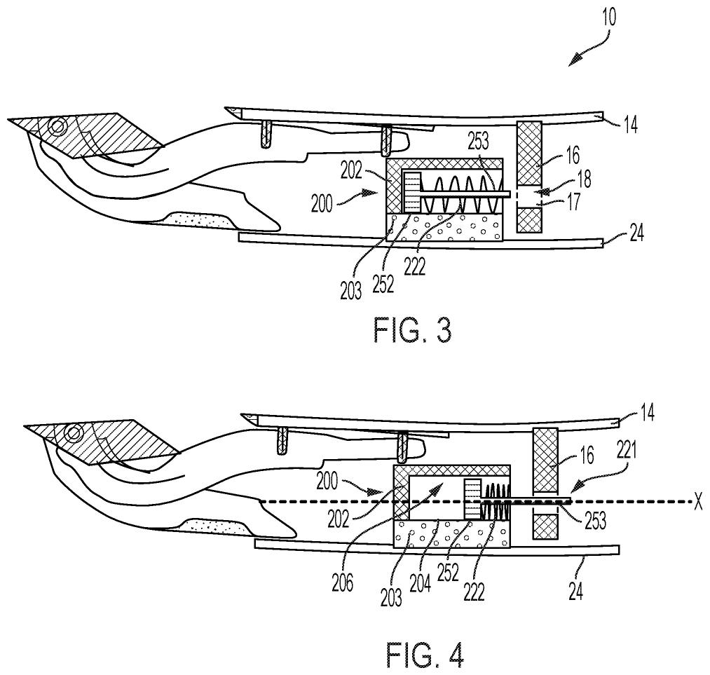

FIGS. 3 and 4 illustrate a dynamic lock mechanism 200, according to another embodiment of the disclosure. The vehicle 10 includes a hood 14 and a windshield (not shown, but similar in position to the windshield 15 shown in FIG. 1). The hood 14 is rotatably attached to the vehicle body, and, upon a sudden deceleration event, may become detached and impact the windshield. The vehicle 10 further includes a bracket 16 coupled to the hood 14. In various embodiments, as shown in FIG. 3, the bracket 16 includes an edge 17 defining an opening 18 configured to engage with a portion of the dynamic lock mechanism 200. The vehicle 10 also includes an upper rail 24, a component of the vehicle body.

The dynamic lock mechanism 200 includes a lock body 202 defining a longitudinal axis X, as shown in FIG. 4. An edge 204 forms an opening 206 in the lock body 202. In various embodiments, the opening 206 extends from a first end of the lock body 202 to a second end of the lock body 202 opposite the first end. The opening 206 is open to the environment at the first end. In various embodiments, the lock body 202 is coupled to a second lock body component 203. In various embodiments, the lock body 202 and the second lock body component 203 are a single, unitary component. In various embodiment, the lock body 202 and/or the second lock body component 203 are coupled to the upper rail 24 of the vehicle 10.

The opening 206 is configured to receive a lock plunger including a lock plunger head 252 and a lock plunger engagement member 253 extending from one side of the lock plunger head 252 such that the lock plunger has a piston-shaped configuration. The lock plunger head 252 and the lock plunger engagement member 253 are configured to travel within the opening 206 in the longitudinal direction X such that at least a portion of the lock plunger engagement member 253 extends out of the opening 206 when the lock plunger engagement member 253 is in an engaged position (as shown in FIG. 4). The lock plunger engagement member 253 has a first end 221 that is configured to engage with the bracket 16. In various embodiments, the first end 221 of the lock plunger engagement member 253 includes a hook that is configured to engage with the opening 18 in the bracket 16.

The lock plunger head 252 is coupled to a tensionable member 222. In various embodiments, the tensionable member 222 is coupled to the same side of the lock plunger head 252 as the lock plunger engagement member 253. The tensionable member 222 is received within the opening 206 and is coupled to the lock plunger head 252 such that the tensionable member 222 is in an extended position when the dynamic lock mechanism 200 is in the disengaged position shown in FIG. 3 and is in a compressed position when the dynamic lock mechanism 200 is in the engaged position shown in FIG. 4. The tensionable member 222 is, in various embodiments, a spring or other tensionable member configured to translate the lock plunger head 252 and the lock plunger engagement member 253 within the opening 206.

During normal operation of the vehicle 10, the dynamic lock mechanism 200 is in the disengaged position shown in FIG. 3. Upon a sudden deceleration event, the spring force of the tensionable member 222 is overcome such that the lock plunger head 252 and the lock plunger engagement member 253 travel longitudinally within the opening 206 in the lock body 202. The lock plunger engagement member 253 translates within the opening 206 such that a first end 221 of the lock plunger engagement member 253 extends through the opening 206 in the lock body 202. The first end 221 of the lock plunger engagement member 253 extends through the opening 18 to engage with the bracket 16, such as, for example and without limitation, a hook engaging with a U-bracket. When the lock plunger engagement member 253 is engaged with the bracket 16, the hood is restrained from incursion into the windshield 15.

In various embodiments, the dynamic lock mechanism 200 also includes a catch member (not shown) and a second tensionable member, similar to the catch member 132 and tensionable member 134 shown in FIGS. 1 and 2 and discussed herein, to engage the lock plunger engagement member 253 in the engaged position shown in FIG. 4.

As noted herein, the dynamic lock mechanisms 100, 200 may also be adapted to retain closure of other vehicle components, such as a glovebox door, hatch, or other component, upon a sudden vehicle deceleration event.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, hut may be approximated and/or larger or smaller, as desired, reflecting acceptable tolerances, conversion factors, rounding off, measurement error and the like and other factors known to those of skill in the art. The term. “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term. “alternatively” refers to selection of one of two or more alternatives and is not intended to limit the selection to only those listed alternatives or to only one of the listed alternatives at a time, unless the context clearly indicates otherwise.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A dynamic lock mechanism, comprising:
a lock body defining a longitudinal axis, the lock body including a first end and a second end opposite the first end, a lock body opening extending along the longitudinal axis from the first end of the lock body to the second end of the lock body, the lock body opening open to the environment at the first end;
a lock plunger configured to travel within the lock body opening such that the lock plunger is fully enclosed within the lock body opening when the lock plunger is in a first position and at least a portion of the lock plunger extends out of the lock body opening when the lock plunger is in a second position, the lock plunger including a retention edge defining a retention channel;
a catch member disposed within the lock body and configured to engage with the retention channel of the lock plunger when the lock plunger is in the second position; and
a first tensionable member coupled to the lock plunger and a second tensionable member coupled to the catch member.

2. The dynamic lock mechanism of claim 1, wherein the first tensionable member is an extension spring and the second tensionable member is a compression spring.

3. The dynamic lock mechanism of claim 1, wherein the lock plunger translates within the lock body opening from the first position to the second position when an inertial force overcomes a spring force of the first tensionable member.

4. The dynamic lock mechanism of claim 3, wherein the first position is a disengaged position of the lock plunger and the second position is an engaged position of the lock plunger.

5. The dynamic lock mechanism of claim 1, wherein the retention channel is perpendicular to the lock body opening.

6. The dynamic lock mechanism of claim 5, wherein the lock body includes an edge defining a receiving opening perpendicular to the lock body opening and the catch member is disposed within the receiving opening.

7. The dynamic lock mechanism of claim 6, wherein when the lock plunger is in the second position, the receiving opening of the lock body is aligned with the retention channel of the lock plunger and the second tensionable member translates the catch member into the retention channel such that the catch member engages with the lock plunger.

8. An automotive vehicle, comprising:
a vehicle body;
a vehicle hood coupled to the vehicle body;
a bracket coupled to the vehicle hood, the bracket including a bracket opening; and
a dynamic lock mechanism coupled to the vehicle body, the dynamic lock mechanism comprising:
a lock body defining a longitudinal axis, the lock body including a lock body opening extending along the longitudinal axis from a first end of the lock body to a second end of the lock body opposite the first end, the lock body opening open to the environment at the first end; and
a lock plunger configured to travel within the lock body opening such that the lock plunger is fully enclosed within the lock body opening when the lock plunger is in a first position and at least a portion of the lock plunger extends out of the lock body opening and engages with the bracket opening in the bracket when the lock plunger is in a second position.

9. The automotive vehicle of claim 8, wherein the lock plunger includes a retention channel and the dynamic lock mechanism further comprises a catch member disposed within the lock body, the catch member configured to engage with the retention channel of the lock plunger when the lock plunger is in the second position.

10. The automotive vehicle of claim 9, wherein the retention channel is perpendicular to the lock body opening.

11. The automotive vehicle of claim 9 further comprising a first tensionable member coupled to the lock plunger and a second tensionable member coupled to the catch member.

12. The automotive vehicle of claim 11, wherein the first tensionable member is a spring.

13. The automotive vehicle of claim 11, wherein the lock plunger translates within the lock body opening from the first position to the second position when an inertial force overcomes a spring force of the first tensionable member.

14. The automotive vehicle of claim 13, wherein the first position is a disengaged position of the lock plunger with respect to the bracket and the second position is an engaged position of the lock plunger with respect to the bracket.

15. The automotive vehicle of claim 11, wherein the lock body includes an edge defining a receiving opening perpendicular to the lock body opening and the catch member is disposed within the receiving opening.

16. The automotive vehicle of claim 15, wherein when the lock plunger is in the second position, the receiving opening of the lock body is aligned with the retention channel of the lock plunger and the second tensionable member translates the catch member into the retention channel such that the catch member engages with the lock plunger.

17. A dynamic lock mechanism, comprising:
a lock body defining a longitudinal axis, the lock body including a lock body opening extending along the longitudinal axis from a first end of the lock body to a second end of the lock body opposite the first end, the lock body opening open to the environment at the first end;
a lock plunger configured to travel within the lock body opening such that the lock plunger is fully enclosed within the lock body opening when the lock plunger is in a first position and at least a portion of the lock plunger extends out of the lock body opening when the lock plunger is in a second position; and
a tensionable member coupled to the lock plunger;
wherein the lock plunger translates within the lock body opening from the first position to the second position when an inertial force overcomes a spring force of the tensionable member.

18. The dynamic lock mechanism of claim 17, wherein the lock plunger includes a lock plunger head and a lock plunger engagement member extending from a first side of the lock plunger head and the tensionable member is coupled to the first side of the lock plunger head.

19. The dynamic lock mechanism of claim 17, wherein the tensionable member is a spring.

20. The dynamic lock mechanism of claim 17, wherein the tensionable member is in an extended position when the lock plunger is in the first position and the tensionable member is in a compressed position when the lock plunger is in the second position and the first position is a disengaged position of the lock plunger and the second position is an engaged position of the lock plunger.
